(19) United States
(12) Patent Application Publication
(10) Pub. No.: US 2026/0153757 A1
(43) Pub. Date: Jun. 4, 2026

(54) PHOTONIC INTEGRATED CIRCUIT AND METHODS RELATED TO THE PHOTONIC INTEGRATED CIRCUIT

(71) Applicant: Tower Semiconductor Ltd., Migdal Haemek (IL)

(72) Inventors: Omer KATZ, Migdal Haemek (IL); Yakov Roizin, Afula (IL); Avi Strum, Haifa (IL)

(73) Assignee: Tower Semiconductor Ltd., Migdal Haemek (IL)

(21) Appl. No.: 18/967,630

(22) Filed: Dec. 3, 2024

(51) Int. Cl. G02F 1/035

(52) U.S. Cl. CPC G02F 1/035

(57) ABSTRACT

A photonic integrated circuit that consists essentially of at least one pair of a first die and a second die. For each pair the second die is bonded to the first die, the first die comprises an unpatterned electro-optical modulation layer that is positioned between a first silicon layer and a first buffering layer; wherein the unpatterned electro-optical modulation layer is made of at least one electro-optical modulation material that is selected of lithium niobate, lithium titanate or barium titanate; and the second die comprises (a) a thinned silicon substrate, (b) backside conductive paths that comprises contact pads accessible from one or more openings that are formed within the thinned silicon substrate, and (c) photonics elements that comprise (i) silicon nitride waveguides that are optically coupled to the unpatterned electro-optical modulation layer, and (ii) one or more photodetectors; wherein the at least one second die lacks a buried oxide layer.

### BACKGROUND OF THE INVENTION

Optical communication is capable of increasing the throughput of communication.

There is a growing need to manufacture integrated circuits in a cost effective manner.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a phase of a manufacturing process of a photonic integrated circuit;

FIG. 2 illustrates an example of a phase of a manufacturing process of a photonic integrated circuit;

FIG. 3 illustrates an example of a phase of a manufacturing process of a photonic integrated circuit;

FIG. 4 illustrates an example of a phase of a manufacturing process of a photonic integrated circuit;

FIG. 5 illustrates an example of a phase of a manufacturing process of a photonic integrated circuit;

FIG. 6 illustrates an example of a phase of a manufacturing process of a photonic integrated circuit;

FIG. 7 illustrates an example of a method; and

FIG. 8 illustrates an example of a method.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY

A photonic integrated circuits that comprises one or more pairs of a fist die and a second die, and methods related to the photonic integrated circuit.

### DESCRIPTION OF THE PREFERRED EMBODIMENTS

According to an embodiment there is provided a photonic integrated circuit that consist essentially of at least one pair of a first die and a second die. According to an embodiment the least one pair forms a first wafer and a second wafer that are bonded to each other—for example—following a surface activation of buffering layers of the at least one pairs of first die and second die—without using a bonding material.

According to an embodiment, “consisting essentially of” limits the scope of a claim to the specified materials or steps “and those that do not materially affect the basic and novel characteristic(s)” of the claimed invention.

According to an embodiment, the photonic integrated circuit does not include at least one triplets of dies—such as having a third die such as a dedicated III-V die.

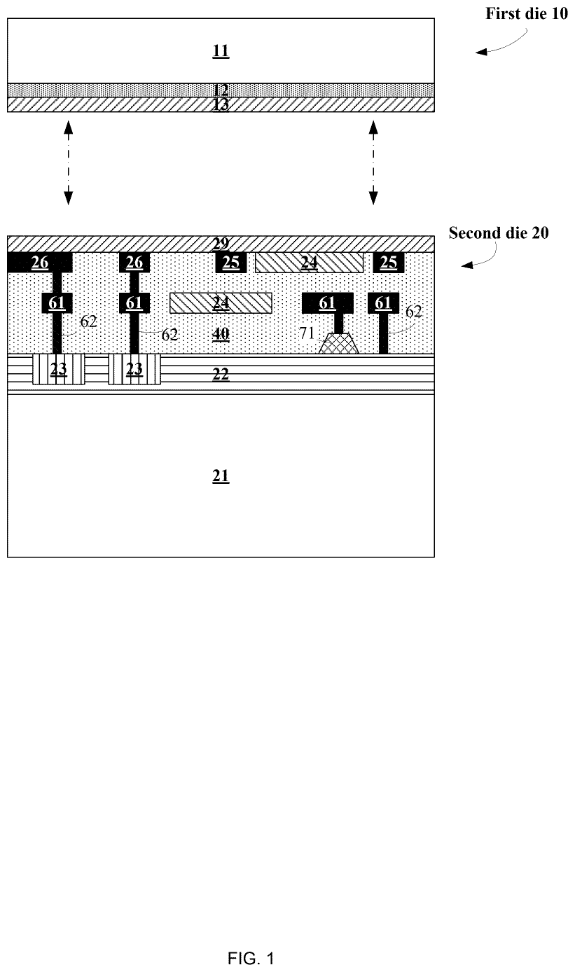

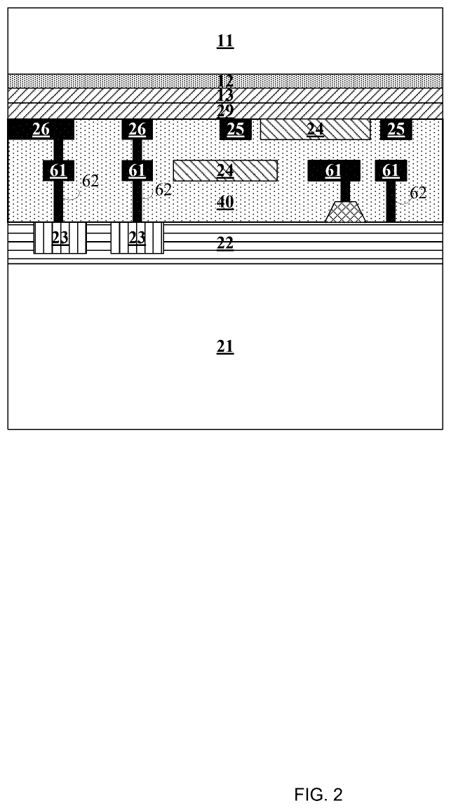

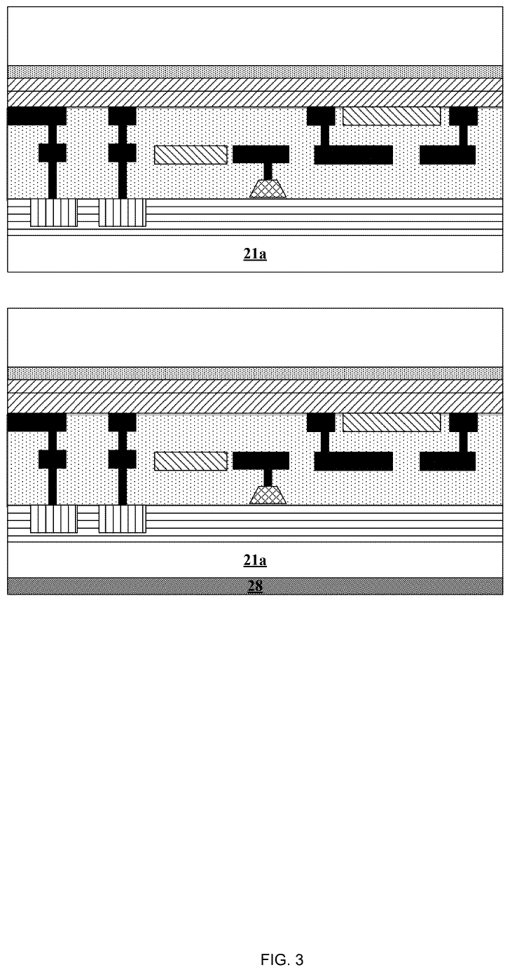

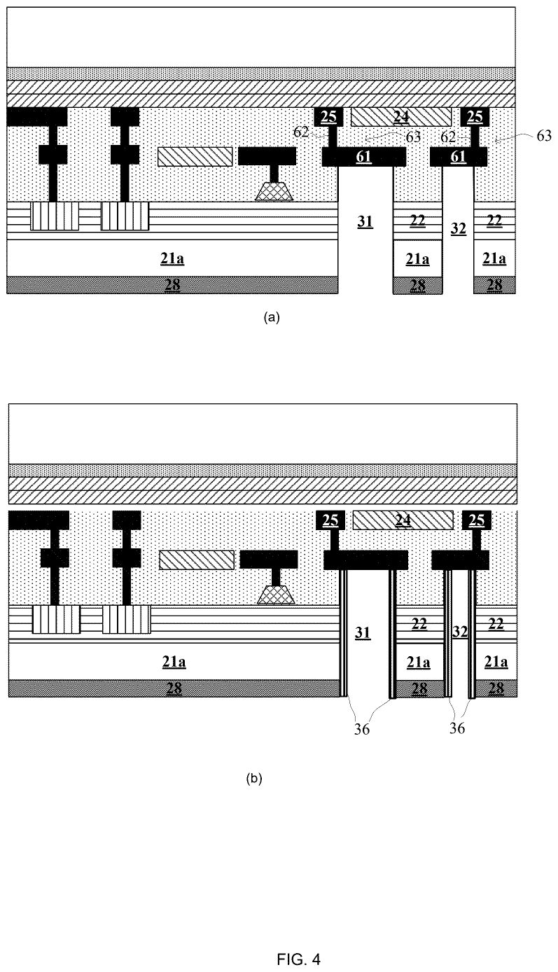

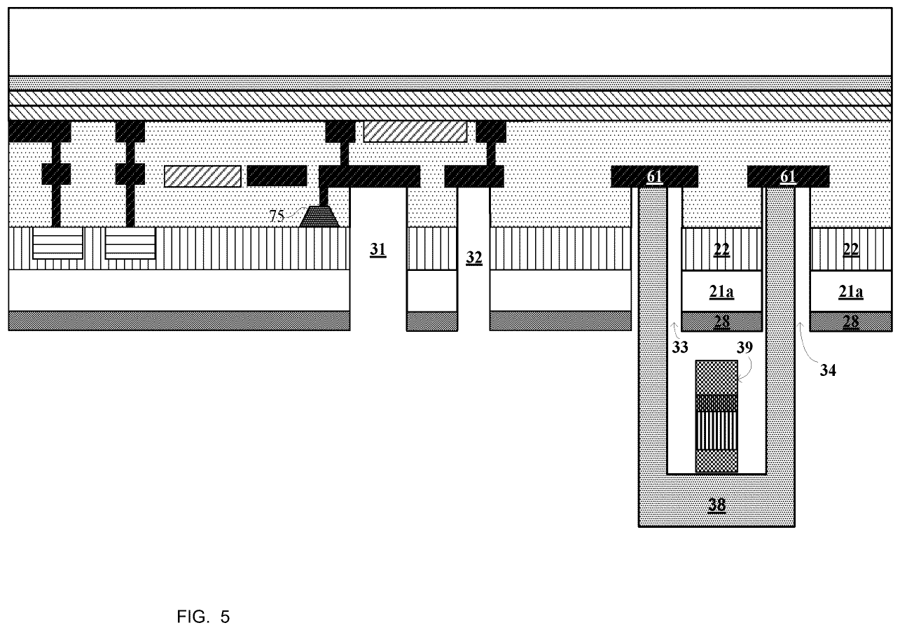

For each die:
a. The second die is bonded to the first die.
b. The first die (denoted 10 in FIG. 1) includes an unpatterned electro-optical modulation layer (denoted 12 in FIG. 1) that is positioned between a first silicon layer (denoted 11 in FIG. 1) and a first buffering layer (denoted 13 in FIG. 1). The unpatterned electro-optical modulation layer is made of at least one electro-optical modulation material that is selected of lithium niobate, lithium titanate or barium titanate.
c. The second die (denoted 20 in FIG. 1) includes (a) a thinned silicon substrate (denoted 21a in FIG. 3), (b) backside conductive paths (denoted 63 in FIG. 4) that include contact pads (denoted 61 in FIGS. 1, 2 and 4) accessible from one or more openings (denoted 31 and 32 in FIGS. 4 and 5, and also denoted 33 and 34 in FIG. 5) that are formed within the thinned silicon substrate, and (c) photonics elements (in one or more photonics layer denoted 40 in FIGS. 1 and 2) that include (i) silicon nitride waveguides (denoted 24 in FIGS. 1, 2, 4 and 6) that are optically coupled to the unpatterned electro-optical modulation layer, and (ii) one or more photodetectors (denoted 71 in FIG. 1). The at least one second die lacks a buried oxide layer.

The second die initially included a silicon substrate (denoted 21 in FIGS. 1 and 2)—and was not a silicon on oxide (SOI) die—therefore the second die lacks a buried oxide layer. The integration of a SOI die to photonic elements are complicated. Using a silicon substrate and not SOI reduces the cost of the manufacturing of the second die and of the photonic integrated circuit and reduces the complexity of the manufacturing process of the photonic integrated circuit.

Using pairs of dies that consists essentially of the first die and the second die decreases the cost and the complexity of the manufacturing the photonic integrated circuit.

It is costly and hard to pattern an electro-optical modulation layer—especially patterning the electro-optical modulation layer to form electro-optical modulation layer elements that match the silicon nitride waveguides. Using an unpatterned electro-optical modulation layer (denoted 12 in FIGS. 1 and 2) reduces the cost and complexity of the manufacturing of the photonic integrated circuit and allows using third party wafers and/or dies that include an unpatterned electro-optical modulation layer.

Using silicon substrate and not SOI as well as having the electro-optical modulation layer unpatterned greatly reduces the cost and complexity of the manufacturing process.

According to an embodiment, the second die is manufactured using complementary metal-oxide semiconductor (CMOS) compatible materials when manufacturing the second die reduces the cost and complexity of the manufacturing process of the second die.

According to an embodiment, a CMOS compatible manufacturing process also includes forming the silicon nitride waveguides (from silicon nitride layers), forming germanium photodiodes, and forming SiGe devices and HV transistors.

According to an embodiment, the CMOS compatible manufacturing process is used for manufacturing the second die to include SiGe modulating transistors (see for example SiGe modulating transistor 75 in FIG. 5) operating up to hundreds of gigahertz as well as silicon photonics devices.

According to an embodiment, the CMOS compatible manufacturing process also includes forming on the same silicon substrate (in one or more photonics layer denoted 40 in FIGS. 1 and 2) silicon nitride waveguides as well high frequency high voltage modulating transistors.

According to an embodiment, following the bonding of the dies to each other, the post-bonding stages merely include thinning the silicon substrate of the second dies and forming openings (for example by etching)—which does not require a high resolution lithography and can be done outside a CMOS fab.

According to an embodiment, the first die is received from another vendor and can be easily bonded to the second die.

According to an embodiment, for each pair, the one or more photodetectors include germanium.

According to an embodiment, for each pair, the second die further includes a second buffeting layer that is bonded to the first buffering layer.

It has been found that the effectiveness of the modulation of the unpatterned electro-optical modulation layer greatly improves with a decrease of the distance between the unpatterned electro-optical modulation layer and modulating electrodes for modulating the unpatterned electro-optical modulation layer.

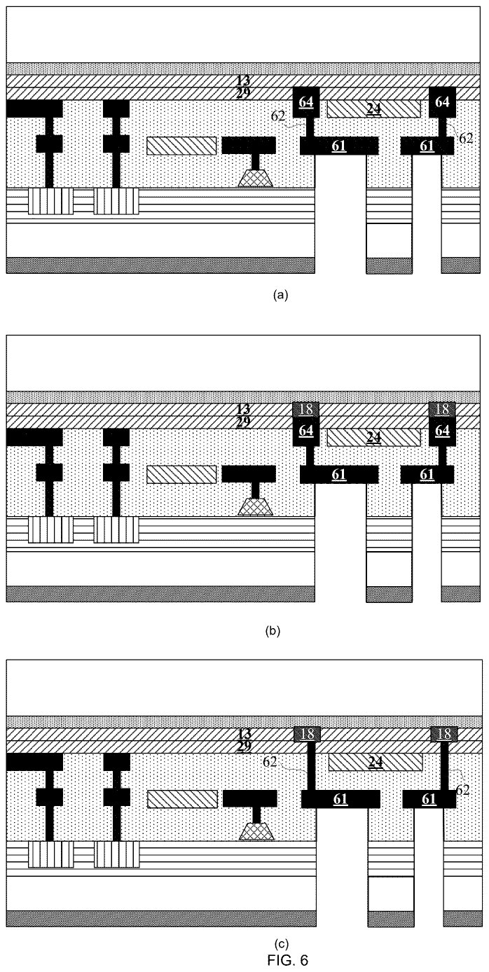

According to an embodiment, for each pair, the modulating electrodes are provided only in the first die—for example in the first buffering layer—see for example FIG. 6—example (c)—modulating electrodes 18 of first die formed within the first buffering layer 13 and are contacted by vias 62 that reach the contact pads 61 of the second die.

According to an embodiment, for each pair, the modulating electrodes are provided only in the second die—for example in the second buffering layer—see for example FIG. 6—example (a)—modulating electrodes 64 of the second die are formed within the first buffering layer 13 and in the one or more photonic layers 40—and are contacted by vias 62 that reach the contact pads 61 of the second die.

According to an embodiment, for each pair, the modulating electrodes are provided in the first die and in the second die—for example in the first and second buffering layers—see for example FIG. 6—example (b)—modulating electrodes 18 of first die formed within the first buffering layer 13 and modulating electrodes 64 of the second die formed within the second buffering layer 29 of the second die).

According to an embodiment, for each pair, when positioned (at least) in the second die, the modulating electrodes (that may be positioned in the second buffering layer) are electrically coupled to a modulation signal source through a modulation conductive path that starts at the second die substrate or at another location below the second buffering layer.

According to an embodiment, for each pair, the first buffering layer includes first modulating electrodes for modulating the unpatterned electro-optical modulation layer, and the second buffering layer include second modulating electrodes that are electrically coupled to the first modulating electrodes.

According to an embodiment, for each pair, one buffering layer of the first buffering layer and the second buffering layer include modulating electrodes for modulating the unpatterned electro-optical modulation layer.

According to an embodiment, the at least one pair is a single pair.

According to an embodiment, the at least one pair are multiple pairs of dies that form a pair of bonded wafers.

According to an embodiment, for each pair, a thickness of the thinned silicon substrate ranges between one and twenty five microns.

According to an embodiment, for each pair, the silicon nitride waveguides include edge couplers.

According to an embodiment, a dielectric layer (denoted 28 in FIG. 3-5) is deposited on the thinned silicon substrate. According to an embodiment the dielectric layer is made of LT SiO2 or ALD alumina having a thickness that ranges between fifty to one hundred and fifty nanometers.

According to an embodiment, for each pair, a thickness of the silicon nitride waveguides ranges between one hundred and ten hundred nanometers.

According to an embodiment, for each pair, the second die includes modulating transistors that are configured to generate modulating signals, wherein the modulating transistors are configured to withstand a high supply voltage having a value of up to forty volts.

According to an embodiment, for each pair, a thickness of the unpatterned electro-optical modulation layer ranges between one hundred to five hundred nanometers.

According to an embodiment, for each pair, a distance between the unpatterned electro-optical modulation layer and the silicon nitride waveguides range between eighty and two hundred nanometers.

According to an embodiment, for each pair, the contact pads are located at a first metal layer of the second die.

According to an embodiment, for each pair, a sidewall of an opening of the one or more opening is coated with dielectric material (denoted 36 in FIG. 4). According to an embodiment the dielectric material does not cover the contact pads.

According to an embodiment, the sidewall is not coated.

According to an embodiment, the coating depends on the packaging technology. For example—when there is a risk of bonding wires contacting the edges of the opening, the coating is applied.

According to an embodiment, the dielectric material used for coating is a low-temperature dielectric, for example CVD/ALD alumina oxide, silicon oxide or silicon nitride.

According to an embodiment, the photonic integrated circuit includes one or more III-V light emitting diodes (denoted 39 in FIG. 5).

According to an embodiment the III-V light emitting diodes are formed on a base (denoted 38 in FIG. 5) that is connected to different contact pads (both denoted 61 in FIG. 5) of one or more openings (denoted 33 and 34 in FIG. 5).

According to an embodiment, the second die includes SiGe circuitry configured to operate at a frequency of up to 500 Ghz.

According to an embodiment, a thickness of the first buffering layer ranges between thirty to one hundred nanometers.

According to an embodiment the first die and second die are bonded using fusion bonding or any other type of bonding.

According to an embodiment the bonding is executed as a temperature of two hundred and fifty degrees Celsius. According to an embodiment the bonding is executed as a room temperature.

According to an embodiment, the bonding is followed by baking at a temperature that ranges between three hundred and four hundred degrees Celsius.

According to an embodiment, the one or more openings are formed using a mask.

According to an embodiment the one or more openings are formed withing a mask—for example by using a light source of the stepper. Typically, photolithography uses a mask to form patterns. When high resolution photolithography is not needed—for example—when forming only a pad openings, the photolithography can include illuminating the photoresist with a focused light beam—without using a mask.

According to an embodiment, the circular shape of the metal electrodes for LED bonding are aligned with the shape of the LED, so that the emitted light is laterally confined in the volume surrounding the LED structure. Light should be sent into the waveguide—by directing a light beam that is parallel to the surface of the chip.

According to an embodiment—this is achieved by positioning the LED inside the opening. From a vertical P-N junction of LED, light is emitted from the sides (parallel to p-n junction plane.). According to an embodiment, the LED is aligned vertically (perpendicular to the plane of SiPho chip) to have optimum coincidence of the emitted light (from P-n junction edges) and the plane of the waveguide.

According to an embodiment, at least one die of the first and second dies undergoes a smoothing process such as chemical mechanical planarization (CMP) before bonding.

According to the embodiment, CMP is done with stop on SiN and then the second buffering layer is deposited.

According to an embodiment, after the waveguides are formed, they are covered with an oxide layer. The surface is not flat, since oxide of uniform thickness is around SiN features. Chemical-mechanical polishing is made (CMP) to the level of SIN. To stop on SiN and not make dishing (deeper areas of oxide around SiN), the coverage of surface with SiN must be uniform. For this, dummy SiN areas are formed. This is followed by depositing thin oxide again and performing another CMP. This allows to have an uniform oxide layer down to 50 nanometers at the surface of SiN waveguides. Accordingly during this process the surface of the second wafer contains dummy SiN structures to make CMP uniform.

According to the embodiment, the thickness of oxide buffering layer is in the range from 10 nm to 100 nm.

According to an embodiment, at least one die of the first and second dies undergoes a plasma treatment before bonding. According to an embodiment, the plasma treatment is applied on at least one of the first buffering layer and the second buffering layer.

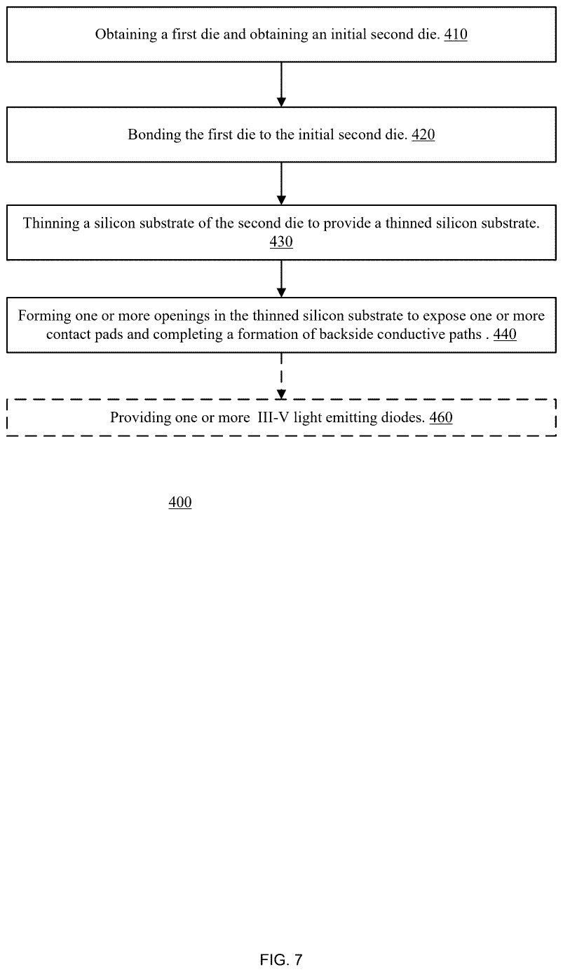

FIG. 7 illustrates an example of method 400 for manufacturing a photonic integrated circuit.

According to an embodiment, method 400 is executed for each pair of dies out of at least one pair of dies. The photonic integrated circuit consists essentially of the at least one pair.

According to an embodiment, and for each die:
a. Method 400 includes step 410 of obtaining a first die and obtaining an initial second die. See FIG. 1. In FIG. 1 the silicon substrate 21 of the second die is not thinned.
b. Step 410 is followed by step 420 of bonding the first die to the initial second die. See FIG. 2. This can be done by activating the surface buffering layers of the first and second dies.
c. Step 420 is followed by step 430 of thinning a silicon substrate of the second die to provide a thinned silicon substrate. See thinned silicon substrate 21a of the second die in FIG. 3—example (a). FIG. 3 example (b) illustrates a dielectric layer 28 that is deposited on the thinned silicon substrate d. Step 430 is followed by step 440 of forming one or more openings (such as openings 31, 32, 33 and 34) in the thinned silicon substrate to expose one or more contact pads and a couple a formation of backside conductive paths (denoted 63 in FIG. 4) that are accessible from the one or more openings. The forming of the openings may be regarded as the completion of the formation of the backside conductive paths. Alternatively—the completion may include coupling the contact pads to external conductors for conveying signals.

According to an embodiment, and for each pair of the at least one pair, step 410 includes receiving or generating the first die that includes the unpatterned electro-optical modulation layer that is positioned between a first silicon layer and a first buffering layer. According to an embodiment, the unpatterned electro-optical modulation layer is made of at least one electro-optical modulation material that is selected of lithium niobate, lithium titanate or barium titanate.

According to an embodiment, and for each pair of the at least one pair, step 410 includes receiving or generating the second die that includes a silicon substrate (that is thinned during step 430), (b) backside conductive paths that are completed during step 450 by having contact pads accessible from one or more openings that are formed during step 440 within the thinned silicon substrate, and (c) photonics elements that include (i) silicon nitride waveguides that are optically coupled to the unpatterned electro-optical modulation layer, and (ii) one or more photodetectors; wherein the at least one second die lacks a buried oxide layer.

According to an embodiment, and for each pair of the at least one pair, step 410 includes receiving or generating a second die in which the one or more photodetectors include germanium.

According to an embodiment, and for each pair of the at least one pair, step 410 includes receiving or generating a second die that includes a second buffeting layer that is bonded to the first buffering layer.

According to an embodiment, and for each pair of the at least one pair, step 410 includes receiving or generating a first die in which the first buffering layer includes first modulating electrodes for modulating the unpatterned electro-optical modulation layer, and receiving or generating a second die in which the second buffering layer includes second modulating electrodes that are electrically coupled to the first modulating electrodes.

According to an embodiment, and for each pair of the at least one pair, step 410 includes receiving or generating a pair in which only one buffering layer of a first buffering layer and a second buffering layer includes modulating electrodes for modulating the unpatterned electro-optical modulation layer.

According to an embodiment, step 440 includes thinning the silicon substrate to have a thickness that ranges between one and twenty five microns.

According to an embodiment, step 410 includes receiving or generating the second die in which the silicon nitride waveguides includes edge couplers.

According to an embodiment, step 410 includes receiving or generating a second die that includes modulating transistors that are configured to generate modulating signals, wherein the modulating transistors are configured to withstand a high supply voltage having a value of up to forty volts.

According to an embodiment, step 410 includes receiving or generating a first die in which a thickness of the unpatterned electro-optical modulation layer ranges between one hundred to five hundred nanometers.

According to an embodiment, step 410 includes receiving or generating a pair in which a distance between the unpatterned electro-optical modulation layer and the silicon nitride waveguides range between eighty and two hundred nanometers.

According to an embodiment, step 410 includes receiving or generating a second die in which the contact pads are located at a first metal layer of the second die.

According to an embodiment, step 410 includes receiving or generating a second die. According to an embodiment, a sidewall of an opening of the one or more opening of the second die is coated with dielectric material.

According to an embodiment the sidewall is not coated.

According to an embodiment, method 400 includes step 460 of providing one or more III-V light emitting diodes—see, for example, FIG. 5).

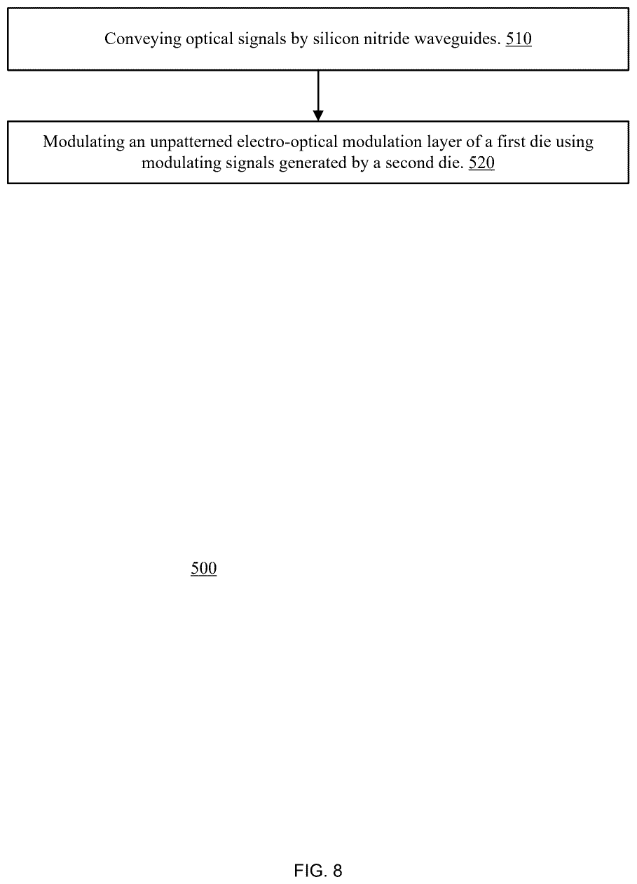

FIG. 8 illustrates an example of method 500 for operating a photonic integrated circuit.

According to an embodiment, method 500 is executed for each pair of dies out of at least one pair of dies. The photonic integrated circuit consists essentially of the at least one pair.

According to an embodiment, method 500 includes step 510 of conveying optical signals by silicon nitride waveguides.

According to an embodiment, step 510 is followed by step 520 of modulating an unpatterned electro-optical modulation layer of a first die using modulating signals generated by a second die. The second die is bonded to the first die. The modulating of the unpatterned electro-optical modulation indirectly modulates the optical signals to provide modulated optical signals.

According to an embodiment, each pair includes a corresponding first die and a corresponding second die. The unpatterned electro-optical modulation layer of the first die is positioned between a first silicon layer and a first buffering layer. The unpatterned electro-optical modulation layer is made of at least one electro-optical modulation material that is selected of lithium niobate, lithium titanate or barium titanate.

The second die includes a thinned silicon substrate, backside conductive paths that includes contact pads accessible from one or more openings that are formed within the thinned silicon substrate, and photonics elements that includes the silicon nitride waveguides and one or more photodetectors. Each second die lacks a buried oxide layer.

Any reference to any of the terms “comprise”, “comprises”, “comprising” “including”, “may include” and “includes” may be applied mutatis mutandis to any of the terms “consists of”, “consisting”, “consisting essentially of”. For example—any of the rectifying circuits illustrated in any figure may include more components than those illustrated in the figure, only the components illustrated in the figure or substantially only the components illustrated in the figure.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “proximal”, “distal”, “front”, “back,” “top”, “bottom”, “over”, “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim

1. A photonic integrated circuit that consists essentially of:
at least one pair of a first die and a second die;
wherein for each pair:
the second die is bonded to the first die;
the first die comprises an unpatterned electro-optical modulation layer that is positioned between a first silicon layer and a first buffering layer; wherein the unpatterned electro-optical modulation layer is made of at least one electro-optical modulation material that is selected of lithium niobate, lithium titanate or barium titanate; and
the second die comprises (a) a thinned silicon substrate, (b) backside conductive paths that comprises contact pads accessible from one or more openings that are formed within the thinned silicon substrate, and (c) photonics elements that comprise (i) silicon nitride waveguides that are optically coupled to the unpatterned electro-optical modulation layer, and (ii) one or more photodetectors; wherein the at least one second die lacks a buried oxide layer.

2. The photonic integrated circuit according to claim 1, wherein for each pair, the one or more photodetectors comprise germanium.

3. The photonic integrated circuit according to claim 1, wherein for each pair, the second die further comprises a second buffeting layer that is bonded to the first buffering layer.

4. The photonic integrated circuit according to claim 3, wherein for each pair, the first buffering layer comprises first modulating electrodes for modulating the unpatterned electro-optical modulation layer, and the second buffering layer comprises second modulating electrodes that are electrically coupled to the first modulating electrodes.

5. The photonic integrated circuit according to claim 3, wherein for each pair, a buffering layer of the first buffering layer and the second buffering layer comprises modulating electrodes for modulating the unpatterned electro-optical modulation layer.

6. The photonic integrated circuit according to claim 1, consists essentially of a single pair.

7. The photonic integrated circuit according to claim 1, wherein for each pair, the at least one pair is a wafer.

8. The photonic integrated circuit according to claim 1, wherein for each pair, a thickness of the thinned silicon substrate ranges between one and twenty five microns.

9. The photonic integrated circuit according to claim 1, wherein for each pair, the silicon nitride waveguides comprise edge couplers.

10. The photonic integrated circuit according to claim 1, wherein for each pair, the second die comprises modulating transistors that are configured to generate modulating signals, wherein the modulating transistors are configured to withstand a high supply voltage having a value of up to forty volts.

11. The photonic integrated circuit according to claim 1, wherein for each pair, a thickness of the unpatterned electro-optical modulation layer ranges between one hundred to five hundred nanometers.

12. The photonic integrated circuit according to claim 1, wherein for each pair, a distance between the unpatterned electro-optical modulation layer and the silicon nitride waveguides range between eighty and two hundred nanometers.

13. The photonic integrated circuit according to claim 1, wherein for each pair, the contact pads are located at a first metal layer of the second die.

14. The photonic integrated circuit according to claim 1, wherein for each pair, a sidewall of an opening of the one or more opening is coated with dielectric material.

15. The photonic integrated circuit according to claim 1, further comprising one or more III-V light emitting diodes.

16. A method for manufacturing a photonic integrated circuit, the method comprises:
for each pair of dies out of at least one pair:
obtaining a first die;
obtaining an initial second die;
bonding the first die to the initial second die;
thinning a silicon substrate of the second die to provide a thinned silicon substrate;
forming one or more openings in the thinned silicon substrate to expose one or more contact pads; and
completing a formation of backside conductive paths that are accessible from the one or more openings;
wherein the photonic integrated circuit consists essentially of the at least one pair;
wherein for each pair:
the first die comprises an unpatterned electro-optical modulation layer that is positioned between a first silicon layer and a first buffering layer; wherein the unpatterned electro-optical modulation layer is made of at least one electro-optical modulation material that is selected of lithium niobate, lithium titanate or barium titanate; and
the second die comprises (a) a thinned silicon substrate, (b) backside conductive paths that comprises contact pads accessible from one or more openings that are formed within the thinned silicon substrate, and (c) photonics elements that comprise (i) silicon nitride waveguides that are optically coupled to the unpatterned electro-optical modulation layer, and (ii) one or more photodetectors; wherein the at least one second die lacks a buried oxide layer.

17. A method for operating a photonic integrated circuit, the method comprises:
conveying optical signals by silicon nitride waveguides; and
modulating an unpatterned electro-optical modulation layer of a first die using modulating signals generated by a second die, the second die is bonded to the first die, wherein the modulating of the unpatterned electro-optical modulation indirectly modulates the optical signals in the silicon nitride waveguide to provide modulated optical signals;
wherein the photonic integrated circuit consists essentially of at least one pair of dies, wherein each pair comprises a corresponding first die and a corresponding second die;
wherein the unpatterned electro-optical modulation layer of the first die is positioned between a first silicon layer and a first buffering layer;
wherein the unpatterned electro-optical modulation layer is made of at least one electro-optical modulation material that is selected of lithium niobate, lithium titanate or barium titanate;
wherein the second die comprises a thinned silicon substrate, backside conductive paths that comprises contact pads accessible from one or more openings that are formed within the thinned silicon substrate, and photonics elements that comprise the silicon nitride waveguides and one or more photodetectors; and
wherein the at least one second die lacks a buried oxide layer.
